(19) United States
(12) Patent Application Publication
(10) Pub. No.: US 2013/0149620 A1
(43) Pub. Date: Jun. 13, 2013

(54) SYSTEM AND METHOD FOR PURGING A FUEL CELL SYSTEM

(71) Applicant: Ardica Technologies, Inc., San Francisco, CA (US)

(72) Inventors: Tibor Fabian, Mountain View, CA (US); Timothy Prowten, San Jose, CA (US)

(73) Assignee: ARDICA TECHNOLOGIES, INC., San Francisco, CA (US)

(21) Appl. No.: 13/710,047

(22) Filed: Dec. 10, 2012

Related U.S. Application Data
(60) Provisional application No. 61/569,123, filed on Dec. 9, 2011.

(51) Int. Cl. H01M 8/04; H01M 8/06

(52) U.S. Cl. CPC H01M 8/04082; H01M 8/06
USPC 429/416; 429/443

(57) ABSTRACT

A method for purging non-fuel gasses from a fuel supply of a fuel cell system, including measuring a first parameter indicative of fuel concentration within the fuel supply, in response to the first parameter measurement satisfying a purge condition, wherein the purge condition is satisfied when the first parameter measurement is indicative of the fuel concentration below a predetermined concentration threshold, opening a purge valve fluidly coupled to the fuel supply and generating a purging pressure within the fuel supply to purge the fuel supply, measuring a second parameter indicative of purge completion, and in response to the second parameter measurement satisfying a purge completion condition, closing the purge valve.

### CROSS-REFERENCE TO RELATED APPLICATIONS

This application claims the benefit of U.S. Provisional Application No. 61/569,123 filed 9 Dec. 2011, which is incorporated in its entirety by this reference.

### TECHNICAL FIELD

This invention relates generally to the fuel cell system field, and more specifically to a new and useful system and method for purging the fuel cell system in the fuel cell system field.

### BACKGROUND

Fuel cell systems provide a good alternative to fossil fuels due to the renewable nature of the fuel and the low carbon footprint of energy production. Fuel cell systems typically include a fuel cell arrangement, which converts a fuel into electricity, and a fuel supply, which supplies fuel to the fuel cell arrangement. With the increased use of portable devices, portability is a desirable feature in energy sources. However, to enable portability of the fuel cell system, fuel supplies must be limited to a portable size, such as to the size of a cartridge. This requirement limits the amount of fuel that can be stored within fuel supply, which, in turn, limits the amount of fuel that can be produced from each cartridge. This limitation results in the requirement that spent cartridges in the fuel cell system must be periodically exchanged with fresh cartridges when the fuel within the cartridge is consumed.

Fuel supply exchange typically requires removal of the fuel supply from the fuel cell system. This decoupling allows non-fuel gasses from the ambient environment to ingress into the connections between fuel supply and fuel cell arrangement, and can even allow ingress into fuel cell arrangement itself. Subsequent connection of the new fuel supply to the fuel cell system traps this ambient air within the fuel cell system, wherein subsequent operation of the fuel cell system forces the gas through the fuel cell arrangement. This proves to be problematic, as the oxidizing agents within the gas (e.g., oxygen, moisture, etc.) degrade the fuel cell anodes and reduce the fuel cell lifespan.

Conventional systems seek to avoid this issue by building up pressure with the fuel and using the pressurized fuel to quickly purge the ambient gas through the fuel cell arrangement (through-stack purging). However, this method not only wastes fuel, but also allows for ambient gas contact with the fuel cells of the fuel cell arrangement. Furthermore, if the fuel supply is a fuel generator, this method can require a long startup time, as a fuel generator needs time to ramp up to produce enough fuel for a purge, much less to build up the pressures required for a rapid purge.

Thus, there is a need in the fuel cell system field to create an improved method of purging a fuel cell system.

### BRIEF DESCRIPTION OF THE FIGURES

FIG. 1 is a schematic representation of a fuel cell system including a purge system.

FIG. 2 is a schematic representation of a fuel cell system to be purged with the purge system and method.

FIG. 3 is a schematic representation of a method of purging a fuel supply for a fuel cell system.

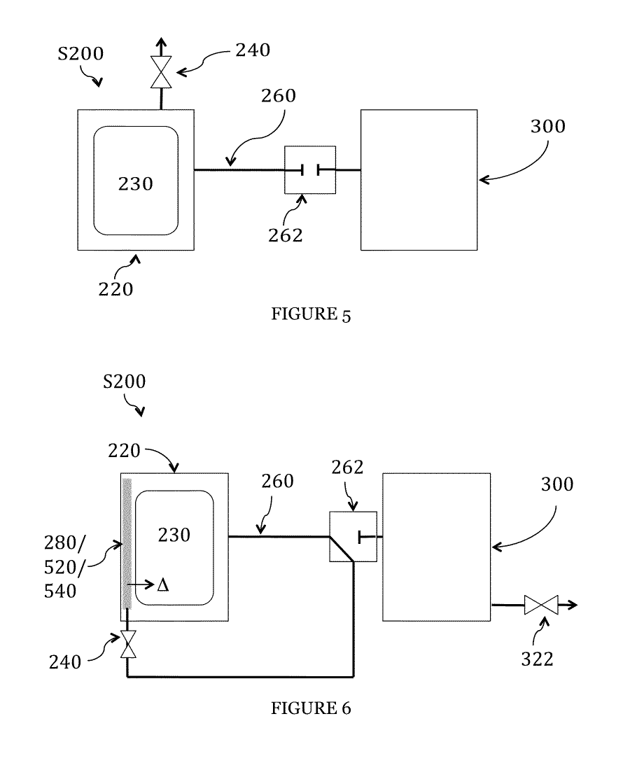

FIGS. 4-8 are schematic representations of a first, second, third, fourth, and fifth variation, respectively, of purging a fuel supply for a fuel cell system.

### DESCRIPTION OF THE PREFERRED VARIATIONS

The following description of the preferred variations of the invention is not intended to limit the invention to these preferred variations, but rather to enable any person skilled in the art to make and use this invention.

### 1. The Purge System

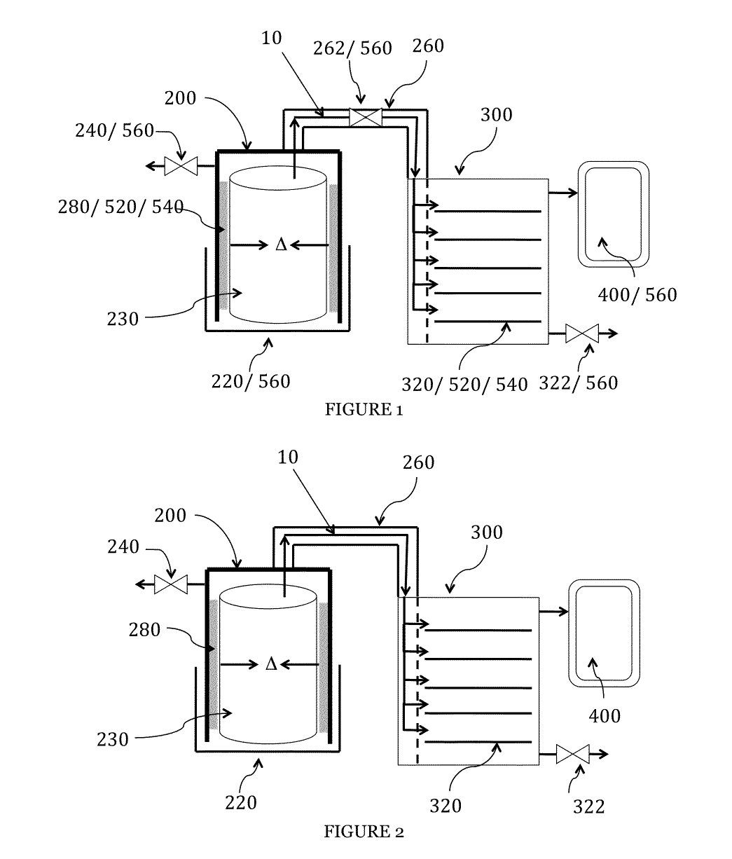

As shown in FIG. 1, the purge system for purging a fuel cell system 100 includes a purge condition detector 520, a purge mechanism 560, and a purge complete detector 540. The purge system is preferably used to remove ambient air from a fuel cell system 100 including a fuel cell arrangement 300 and a fuel supply 200. Ambient air can enter the fuel cell system 100 during fuel cartridge exchange, during periods of non-use, or during fuel cell system operation, such as when the fuel supply 200 is inadequately sealed. It is desirable to purge this ingressed ambient air, as the air can contain oxidizing agents, such as oxygen and moisture that deteriorate the fuel cell anodes and subsequently, reduce the fuel cell lifespan if the air is passed over the fuel cell anodes during fuel cell operation. The purge system functions to purge the ambient air from the cavities of the fuel cell system 100. More specifically, purge system removes the ambient air ingressed into the fuel connection 260 between the fuel supply 200 and the fuel cell arrangement 300, and can additionally purge ambient air from the fuel supply 200 and the fuel supply compartment 220.

The purge system preferably routes the air around the fuel cell arrangement 300, such that the ambient air does not contact the fuel cells 320 within the fuel cell arrangement 300. The purge system can or can not purge the ambient air ingressed into the fuel cell arrangement 300; in some scenarios, the volume of air trapped within the fuel cell arrangement 300 can be negligible compared to the volume trapped within the fuel connection 260 and/or fuel supply compartment 220.

### 1.1 The Fuel Cell System

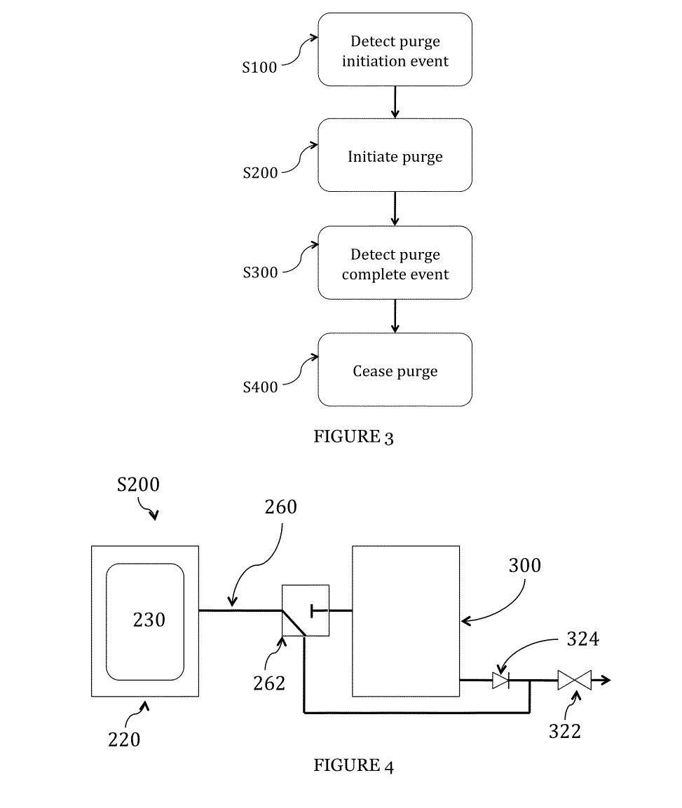

As shown in FIG. 2, the fuel cell arrangement 300 of the fuel cell system 100 functions to convert fuel 10 into electric power. Fuel 10 is preferably provided by a fuel supply 200 integrated into or separate from the fuel cell system 100, but can alternatively be provided by any suitable fuel source. The fuel cell arrangement 300 can be coupled to an external load, such as a rechargeable battery (e.g., lithium ion or any other suitable chemistry), a consumer portable device, a mobile device, an entertainment device, a vehicle, or any other suitable power-consuming load. The fuel cell arrangement 300 preferably includes one or more fuel cells 320 electrically coupled in series or in parallel within a fuel cell stack 300. The fuel manifolds of the fuel cells 320 within the fuel cell stack 300 can be fluidly coupled in series or in parallel. The air manifolds of the fuel cells 320 within the fuel cell stack 300 can be coupled in series or in parallel. Each fuel cell 320 preferably includes a fuel inlet manifold and a fuel outlet manifold fluidly connected to the anode, and an air inlet manifold and an air outlet manifold fluidly connected to the cathode. However, the fuel cells 320 can alternatively have any suitable configuration. The fuel cells 320 are preferably high temperature fuel cells 320, such as solid oxide fuel cells 320 (SOFCs) and molten carbonate fuel cells 320 (MCFCs), but can alternatively be low temperature fuel cells 320 (e.g., proton exchange membrane fuel cells 320) or any other suitable fuel cell 320. The fuel cells 320 preferably convert hydrogen to electric power, but can alternatively convert butane, propane, methane, or any suitable fuel 10 into electricity. The fuel cells 320 are preferably planar, but can alternatively be tubular or any suitable shape.

The fuel cell arrangement 300 preferably includes a fuel cell purge valve 322 that functions to purge the fuel cell arrangement 300 of non-fuel matter generated by the fuel cell 320 during operation. The fuel cell purge valve 322 is preferably coupled to the last cell of the fuel cell arrangement 300, but can be coupled to a common manifold that is coupled to the fuel- or air-outlet manifolds of the fuel cells 320. The fuel cell purge valve 322 is preferably coupled downstream from the fuel cell arrangement 300. The fuel cell purge valve 322 is preferably passive, but can alternatively be actively controlled by a processor. Passive valves that can be used include unidirectional valves, wherein a pressure increase within the fuel cell arrangement 300 results in a purge. Examples of unidirectional valves include ball valves and check valves. The passive valve can also be a bidirectional valve (e.g., a dome valve), a three-port valve (e.g., three way pall valve, shuttle valve, etc.), or any other suitable valve. Active valves that can be used include solenoid valves, hydraulic valves, pneumatic valves or motor valves, and can be unidirectional, bidirectional, or 3-way valves. The fuel cell purge valve 322 preferably has a cracking pressure above 1 psi, but can alternatively have any suitable cracking pressure.

The fuel supply 200 of the purge system functions to provide fuel 10 for the fuel cell system 100. The fuel supply 200 is preferably at least partially integrated into the fuel cell system body, but can alternatively be a separate component that couples with the fuel cell system 100. The fuel supply 200 preferably includes a fuel supply compartment or dock that accepts and fully encapsulates a fuel cartridge 230, but the fuel supply 200 can alternatively couple to the fuel outlet of the fuel cartridge 230. The fuel cartridge 230 preferably includes a volume of fuel storage composition that stores fuel 10 in chemically bound form, such as a metal hydride (e.g., aluminum hydride, sodium borohydride, lithium hydride, etc.), but can alternatively include pressurized fuel 10 or any other suitable form of fuel storage. In operation, fuel 10 preferably egresses out of the fuel source, fills the internal volume of the fuel supply compartment, and flows out of a fuel egress port into the fuel cell arrangement 300. The fuel supply 200 is preferably a fuel generator that reacts the fuel storage composition to produce fuel 10, but can alternatively be any suitable fuel supply 200. A fuel generator can be preferable as the fuel supply 200 due to the high energy densities afforded by the fuel storage compositions used in fuel generators. In this variation, the fuel supply compartment preferably includes a reaction element that reacts the fuel storage composition to generate fuel 10. The reaction element is preferably a heating element that thermally interfaces with conductive elements on the cartridge, but can alternatively be electrical connections that power heaters within the cartridge, a pump that pumps a reactant to a fuel storage composition reaction front, or any other suitable mechanism that facilitates fuel storage composition reaction. The fuel 10 provided by the fuel supply 200 is preferably hydrogen gas, but can alternatively be methane, propane, or any suitable fuel.

The fuel supply 200 and/or fuel cartridge 230 can include a pressure release valve 240 that functions to vent the fluid within the fuel supply 200 to a purge reservoir, such as the ambient environment. The pressure release valve 240 preferably functions as a pressure relief valve, wherein the pressure release valve 240 is in an open configuration when the internal pressure of the fuel supply 200 exceeds a predetermined pressure threshold. However, the pressure release valve 240 can function as a purge valve, fuel supply valve 262, or any other suitable valve. The pressure release valve 240 is preferably passive, but can alternatively be actively controlled by a processor. Passive valves that can be used include unidirectional valves, wherein fuel supply 200 pressure increase beyond the pressure threshold in a purge. The valves that can be used for the pressure release valve 240 are substantially similar to those described above for the fuel cell purge valve 322. The threshold pressure is preferably below the maximum acceptable stack pressure (e.g., 3 psi), but can alternatively have any suitable threshold pressure. The pressure release valve 240 is preferably arranged at or near the bottom of the fuel supply 200, such that heavier and/or denser fluids (e.g., non-fuel gasses and combustion products) are proximal the pressure release valve 240 prior to a purge.

The fuel supply 200 is preferably coupled to the fuel cell arrangement 300 by one or more connections. In particular, the fuel cell system 100 (including the fuel cell arrangement 300 coupled to the fuel supply 200) preferably includes a fuel connection 260 fluidly connecting the fuel supply 200 to the anodes of fuel cell arrangement 300. The fuel cell system 100 can also include other connections between the fuel cell arrangement 300 and the fuel supply 200. The fuel connection 260 preferably creates a substantially airtight and gas impermeable fluid path between the fuel egress port of the fuel supply 200 and the fuel ingress port of the fuel cell arrangement 300. The fuel connection 260 is preferably located near the top of the fuel supply 200, but can alternatively be located near any suitable portion of the fuel supply 200. Connections connecting the fuel supply 200 and the fuel cell arrangement 300 can additionally include electrical connections (e.g., to power the fuel generation mechanism), data connections, or any other suitable connections.

In a first variation, the fuel connection 260 includes substantially flexible tubing that couples the fuel egress port of the fuel supply 200 to the fuel ingress port of the fuel cell arrangement 300. The tubing ends can be sealed to the respective ports by an interference fit, sealed with a washer slid over the tubing and port, welded, screwed, adhered, or utilize any other suitable coupling mechanism to couple with the ports. The tubing is preferably made of (or coated with) a material substantially inert to the fuel 10, and is preferably polymeric (e.g., silicone, PTFE, etc.), but can alternatively be metallic. In a second variation, the connection includes a channel, preferably defined by the fuel cell system 100 casing, that fluidly couples the fuel supply 200 to the fuel cell system 100. This variation can be preferred when the fuel supply 200 is a fuel generator integrated into the fuel cell system 100 (e.g., an integral unit with the fuel cell arrangement 300). In a third variation, the connection includes a direct port-to-port connection, wherein the ports can be screwed, clipped, clamped, or otherwise coupled together.

The fuel connection 260 can additionally include one or more fuel supply valves 262 that function to regulate fuel flow between the fuel supply 200 and the fuel cell arrangement 300. However, in some variations, the fuel supply valve 262 can be excluded, such that the connection is open to the environment once the fuel supply 200 is uncoupled. The fuel supply valve 262 can be located along an intermediary portion of the fuel connection 260, in or near either the fuel egress port of the fuel supply 200 or the fuel ingress port of the fuel cell arrangement 300. Alternatively, the fuel connection 260 can include multiple valves located at one or more of the aforementioned positions. The fuel supply valve 262 is preferably a three-way valve that fluidly connects the fuel supply 200 to the fuel cell arrangement 300 and a purge reservoir (e.g. ambient environment), but can alternatively fluidly connect the fuel supply 200 to the fuel cell arrangement 300 and a purge complete detector 540. In one variation, the fuel supply valve 262 is connected to the purge reservoir through the fuel cell purge valve 322. The fuel supply valve 262 fluidly connects the fuel supply 200 to the fuel cell arrangement 300 and the fuel cell purge valve 322, wherein the fuel supply valve 262 can fluidly connect to the connection between the fuel cell stack and the fuel cell purge valve 322, wherein the connection between the fuel cell stack and the fuel cell purge valve 322 preferably further includes a one-way valve 324 located upstream from the fuel supply valve connection that prevents fluid flow from the fuel supply valve connection to the fuel cell stack 300 and permits fluid flow from the fuel cell stack 300 to the fuel cell purge valve 322. Alternatively, the fuel supply valve 262 can directly connect to the fuel cell purge valve 322, wherein the fuel cell purge valve 322 is preferably a three-way valve that receives fluid from the fuel supply valve 262 and the fuel cell stack, and purges the received fluid into a purge reservoir. Alternatively, the fuel cell system can include a first fluid connection between the fuel supply 220 and the fuel cell stack 300 having a fuel supply valve 262, and a second fluid connection between the fuel supply 220 and the fuel cell purge valve 322 having a second purge valve that controls purge stream flow from the fuel supply 220 to the fuel cell purge valve 322. The fluid connection between the fuel supply valve 262 and the purge reservoir or purge complete detector 540 is preferably thermally connected to the fuel cell stack 300, but can alternatively be thermally isolated from the fuel cell stack. Alternatively, the fuel supply valve 262 can be a one-way valve that permits one-way flow from the fuel supply 200 to the fuel cell arrangement 300, a two-way valve, or any other suitable valve. The fuel supply valve is preferably active, but can alternatively be passive. The valves that can be used for the connection valve are substantially similar to those described above for the fuel cell purge valve 322.

The fuel connection 260 can additionally include a common manifold that feeds the fuel inlet manifolds of the fuel cells 320 (e.g., the flow paths over the fuel cell anodes). In this variation, fuel 10 preferably flows from the fuel supply 200, through the fuel connection 260, into the common manifold, and into the fuel inlet manifolds. The common manifold can feed the fuel flow fields of the fuel cell 320 assembly in series or in parallel. The common manifold can include a valve at the fuel supply connection junction, and/or can include a valve at one or more of the fuel inlet manifold junctions.

The fuel cell system 100 can additionally include a load regulator 400 that functions to control power draw from (i.e. the electrical load on) the fuel cell arrangement 300. The load regulator 400 is preferably integrated into the fuel cell system 100, but can alternatively be a separate component that can be coupled to the fuel cell system 100, or a component of the device powered by the fuel cell system 100. The load regulator 400 is preferably electrically connected to the power outlet of the fuel cell arrangement 300. The load regulator 400 preferably controls the current draw, but can alternatively control the fuel cell arrangement voltage (e.g., by controlling the electrical connections of the fuel cells 320), or control any other suitable parameter of the fuel cell arrangement 300 to control power draw. The load regulator 400 is preferably a mechanism that controls the power available to a load, such as a DC/DC converter or any other suitable current or voltage control mechanism. The load regulator 400 can alternatively be the load 420 itself, and can be an adjustable load operable between a high power draw state, a low power draw state, and any intermediate state therebetween (e.g., wherein the adjustable load has an adjustable resistance), a non-adjustable load operable in an on state or an off state, or any other suitable load that can draw power from the fuel cell system 100.

The fuel cell system 100 can additionally include a controller that functions to control fuel cell system 100 operation. The controller is preferably a processor, but can alternatively be a mechanical control system or any suitable controller. The controller can control fuel cell system 100 startup, control fuel cell system 100 shutdown, control the reaction mechanism 280 at the fuel supply 200 to control fuel generation, determine the power requirements of a load, control power draw from the fuel cell arrangement 300, control the pressure of the fuel supply 200, control the pressure of the fuel cell arrangement 300, control fuel supply purge stream routing, receive and process fuel supply 200 parameter measurements, determine the satisfaction of a fuel supply purge condition, determine purge completion, or otherwise control fuel cell system 100 and fuel supply 200 operation. The controller is preferably integrated into the body of the fuel cell arrangement 300, but can alternatively be a separate component couplable to the fuel cell system 100, be located within the fuel supply 200, be located within the fuel cartridge 230, or be located in any suitable element of the fuel cell system 100.

### 1.2 The Purge Mechanism

During periods of inactivity or after the fuel supply 200 has been decoupled from the fuel cell system 100, ambient air can ingress into one or more areas of the fuel cell system 100. Ambient air can ingress into the fuel connection 260, the fuel cell arrangement 300, and/or the fuel supply compartment. This ambient air can contain oxidants (e.g., oxygen, moisture, etc.) that can degrade the fuel cells 320. As the air contained within one or more of the aforementioned areas can be pushed into the fuel cell arrangement 300 and expose the anodes to the oxidants for a prolonged period of time during fuel generation startup, it is desirable to purge at least the air trapped within the fuel connection 260, if not the air within the fuel supply compartment 220 and/or fuel cell 320 assembly, while minimizing or eliminating air contact with the anodes. This is preferably accomplished with the purge mechanism 560 of the purge system.

The purge mechanism 560 of the purge system functions to remove the ambient air from the fuel connection 260 of the fuel cell system 100. More preferably, the purge mechanism 560 preferably includes a pressurization mechanism functions to increase the internal pressure of the fuel cell system 100 such that a rapid purge of the fuel cell arrangement 300 can be achieved. The pressurization mechanism can be the fuel supply 200, more specifically the fuel generator, wherein fuel generation pressurizes the fuel supply 200 and/or fuel cell system 100. The pressurization mechanism can alternatively be a pump coupled downstream from the fuel cell arrangement 300, more preferably near or within the fuel supply compartment 220. The purge mechanism 560 can additionally function to remove the ambient air from the fuel supply compartment 220. The purge mechanism 560 preferably includes a controller that controls initiation and completion of air removal from the system. However, the purge mechanism 560 can alternatively be passively controlled (e.g., a using temperature-based actuation mechanism, pressure-based actuation mechanism, etc.), or otherwise controlled. The purge mechanism 560 preferably leverages an existing system valve (e.g., the fuel cell purge valve 322, pressure release valve 240, etc.) or a separate valve, wherein the valve functions as a purge valve. The controller preferably initiates the air removal by increasing the internal pressure past the cracking pressure of the purge valve or by actuating the purge valve. However, the purge mechanism 560 can be any suitable mechanism that removes the ambient air from the cavities of the fuel cell system 100, such as a vacuum.

The purge condition detector 520 of the purge system functions to determine a need for a fuel supply purge. The purge condition detector 520 preferably measures a parameter indicative of fuel concentration within the fuel supply 200, and determines that a purge condition is met when the indicated fuel concentration is below a predetermined fuel concentration threshold. In a first variation, the purge condition detector 520 detects fuel cartridge replacement, wherein the purge condition is satisfied when a fuel cartridge 230 is newly connected to the fuel supply 200. The purge condition detector 520 can determine the connection state of a fuel cartridge 230 with the fuel supply 200, wherein the purge condition is satisfied when the fuel cartridge connection state transitions from disconnected to connected. The purge condition detector 520 can alternatively determine a unique fuel cartridge identifier, wherein the purge condition is satisfied when a different fuel cartridge identifier is detected. However, any other purge condition detector 520 can be used to determine fuel cartridge insertion or replacement. In a second variation, the purge condition detector 520 is an oxygen sensor that detects the oxygen concentration within the fuel supply 200. The oxygen sensor can be a catalyst that reacts fuel 10 with oxygen (e.g., metals from the Platinum group, oxides of silver, cobalt, manganese, or any other suitable catalyst), wherein a temperature change (preferably an increase beyond a temperature threshold, as in the case of an endothermic combustion, but alternatively a decrease beneath a temperature threshold) at the catalyst site is indicative of the presence of oxygen within the fuel supply 200. The catalyst can be located in the fuel supply 200 and function as a reaction mechanism 280 for the fuel supply 200 (e.g., wherein the fuel storage composition thermolyses to generate fuel 10), in the fuel connection 260, in the purge stream, in a purge stream reservoir, in any other suitable location. The catalyst preferably coats a porous matrix (e.g., metallic, ceramic, or polymeric), and is preferably in the form of a bed but can alternatively be in the form of a tube or any suitable form factor. However, the oxygen sensor can detect the oxygen concentration within the fuel supply 200, the presence of oxygen within the fuel supply 200, or any other suitable parameter of oxygen within the fuel supply 200. In a third variation, the purge condition detector 520 is the controller, wherein the purge condition is met when the controller initiates fuel cell system startup. In a fourth variation, the purge condition detector 520 is a fuel cell anode, wherein the purge condition is met when power provided by a fuel cell drops, indicative of a decrease in the fuel concentration within a fuel stream. Alternatively, the purge condition can be met when the power provided by the fuel cell 320 is lower than anticipated, based on the fuel generation rate and fuel cell parameters indicative of fuel cell performance (e.g., age, temperature, etc.). In a fifth variation, the purge condition detector 520 is the cathode, wherein the purge stream is routed over the cathode. A purge stream containing fuel 10 and oxygen will exothermically react at the cathode, wherein the purge condition is met when a temperature increase at the cathode is detected (e.g., by a temperature sensor connected to the fuel cell 320). In sixth variation, the purge condition detector 520 is a flow sensor that measures the fuel flow rate from the fuel cartridge 230, wherein the purge condition is met when fuel flow rate falls below a predetermined flow rate threshold. Alternatively, any combination of the aforementioned or any other suitable purge condition detector 520 can be used.

The purge complete detector 540 of the purge system functions to determine the completion of a purge. The purge complete detector 540 is preferably the same sensor or detection mechanism as the purge condition detector 520, but can alternatively be a separate component. In a first variation, the purge complete detector 540 includes a timer, wherein the purge is ended after a predetermined period of time. In a second variation, the purge complete detector 540 is the purge valve, wherein the purge valve automatically closes at a predetermined pressure. In a third variation, the purge complete detector 540 is an oxygen sensor. The oxygen sensor can be a catalyst that reacts with the fuel 10 (e.g., metals from the Platinum group, oxides of silver, cobalt, manganese, or any other suitable catalyst), wherein a temperature change (preferably decrease, but alternatively increase) at the catalyst site functions as a purge completion condition. The catalyst can be located in the fuel connection 260 (e.g., in the fuel flow path between the fuel supply 200 and the fuel cell arrangement 300), in the fuel generator, in the purge stream, in the purge stream reservoir, or in any suitable location. However, the oxygen sensor can detect the oxygen concentration within the fuel supply 200, the presence of oxygen within the fuel supply 200, or any other suitable parameter of oxygen within the fuel supply 200. In a fourth variation, the purge complete detector 540 is the anode of a fuel cell 320 (sacrificial fuel cell 320). The purge stream is routed over the fuel cell anode, wherein the completion event is an increase in power from the fuel cell 320, indicative of a substantially pure-fuel purge stream. In this variation, the purge stream is preferably routed over a different fuel cell 320 within the fuel cell arrangement 300 each time a purge is initiated (e.g., the sacrificial fuel cell 320 is a different fuel cell 320 each purge), such that the average life of the fuel cell arrangement 300 is prolonged. However, the purge mechanism 560 can include any other suitable purge complete detectors 540. In a fifth variation, the purge complete detector 540 is the cathode of a fuel cell 320 (sacrificial fuel cell 320). The purge stream is routed over the fuel cell cathode, wherein the fuel 10-oxygen mixture exothermically reacts with the cathode. The completion event can be a decrease in power from the fuel cell 320 or a reduction in the rate of cathode heating, both indicative of a substantially pure-fuel 10 purge stream. In a sixth variation, the purge complete detector 540 is a fuel generation sensor that measures a parameter of fuel 10 pressure within the fuel supply 200, wherein the completion event is an increase of the fuel 10 pressure beyond a pressure threshold, indicative of a high enough rate of fuel generation to rapidly push the ambient air through the fuel cell 320 assembly. The fuel generation sensor can be a pressure sensor within the fuel supply 200, a fuel sensor that detects the concentration of fuel 10 within the system, a flow rate sensor that measures the fuel flow rate out of the fuel cartridge 230, or any other suitable fuel sensor. Alternatively, any combination of the aforementioned or any other suitable purge condition detector 520 can be used.

### 2. The Method of Purging a Fuel Cell System

As shown in FIG. 2, the method of purging a fuel cell system includes the steps of detecting a purge condition S100, initiating a purge S200, detecting a purge completion condition S300, and ceasing the purge S400. The method preferably utilizes a purge mechanism, similar to those described above, to purge a fuel cell system substantially similar to that describe above. More specifically, the method removes ambient air from the cavities of the fuel cell system, such as the fuel connection and the fuel supply dock. The fuel cell assembly is preferably not operated during operation of this method (e.g., the fuel cell assembly preferably does not provide power to the load), but can alternatively be operated at partial capacity (e.g., only several of the fuel cells within the assembly are operated, fuel cells are operated at partial load) or at full capacity during the purge. The purge is preferably passively controlled, but can alternatively be actively controlled.

Detecting a purge condition S100 functions to indicate the need for a purge. This step preferably includes measuring a parameter indicative of ambient air in the system, more preferably indicative of fuel concentration within the fuel supply being below a predetermined fuel concentration threshold and/or the oxygen concentration within the fuel supply being above a predetermined oxygen concentration. The purge condition is preferably satisfied when the measured parameter indicates that the fuel concentration within the fuel supply is below a predetermined threshold. The purge condition is preferably detected by a purge condition detector as described above, but can alternatively be detected by any suitable sensor and/or determined by any suitable processor.

In a first variation, the purge condition is initial fuel cell system operation, wherein a parameter indicative of fuel cell system operation state is measured. Detection of initial fuel cell system operation can include detection of system initiation (e.g., system is turned on), detection of a load coupled to the system, detection of a fuel cell temperature below an operational temperature, or detection of any other suitable parameter indicative of fuel cell system startup. Alternatively, the purge initiation can be manual actuation of a button, such as placement of the fuel cell system power button into the “power generation” position (i.e. “on” position). Purge initiation preferably automatically occurs when the fuel cell system is initiated, but can be dependent on the controller of the purge mechanism detecting the purge condition.

In a second variation, the purge condition is cartridge replacement. Cartridge replacement can be detected mechanically (e.g., the cartridge actuates a mechanism when coupled to the system, etc.), electrically (e.g., the cartridge completes a circuit, etc.), thermally (e.g., the lower temperature fresh cartridge lowers the temperature of the fuel supply compartment), visually (e.g., the fuel supply compartment determines a change in cartridge ID), manually (e.g., the user actuates the purge mechanism), or in any other manner.

In a third variation, the purge condition is receipt of a signal from a sensor, such as a purge condition detector. This variation is preferably utilized during system operation, and functions to detect the presence of ambient air in the fuel stream (e.g., through a leak, cartridge removal, etc.). In a first example, the purge initiation detector is a temperature sensor disposed near a catalyst, wherein the catalyst is located within the fuel supply dock, such that it is bathed in a fuel-rich environment during system operation. An increase in temperature (near the catalyst) functions as the purge initiation signal, as ambient air ingress into the fuel supply dock supplies oxygen to the catalyst, which combusts the oxygen with the fuel to produce heat. In a second example, the purge initiation detector monitors the voltage of one or more fuel cells within the fuel cell system, wherein a decrease in the voltage and/or power of a fuel cell serves as the purge initiation signal. In the instance of ambient air leakage into the fuel cell system, the ambient air will displace a volume of fuel within the fuel connection, resulting in less fuel provided to the fuel cell anodes and subsequently, less power produced from the fuel cell.

Initiating a purge S200 functions to purge the fuel cell system. The purge preferably purges non-fuel fluids from the fuel supply into a purge reservoir, wherein the purge reservoir is preferably the ambient environment but can alternatively be any suitable reservoir. The purge preferably routes the ambient air to be purged about the fuel cell arrangement, but can alternatively purge the ambient air through the fuel cell arrangement.

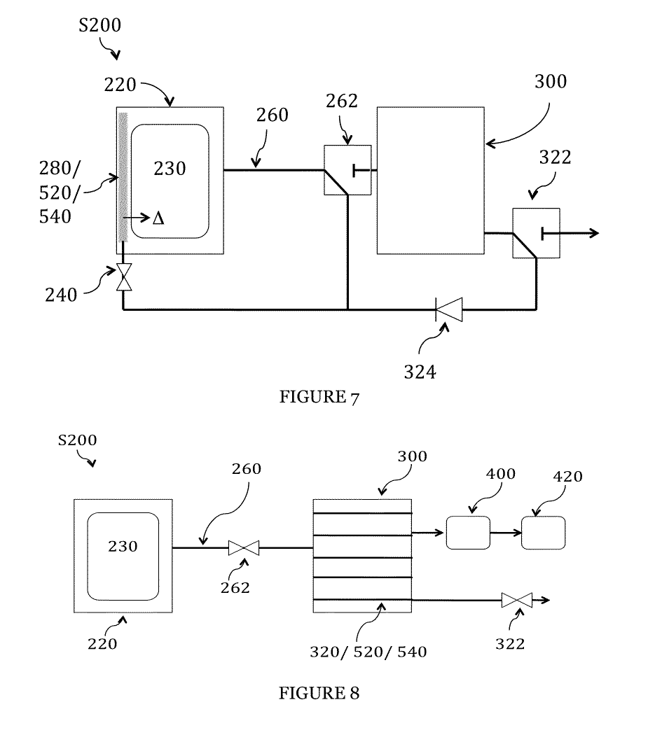

In a first variation, as shown in FIG. 4, ambient air is removed from the fuel cell system by purging the ambient air through the fuel cell purge valve (FCPV) while bypassing the fuel cell arrangement. This variation is preferably used with a fuel cell system including a three-way fuel supply valve located between the fuel source fuel egress port and the fuel ingress port of the fuel cell assembly, wherein the supply valve includes an inlet fluidly connected to the fuel supply, a first outlet fluidly connecting the supply valve to the anodes of the fuel cell assembly, and a second outlet fluidly connecting the supply valve to the FCPV of the fuel cell assembly. Alternatively, this variation can be used with a fuel cell system including a pressure relief valve that directs fluid from the fuel supply to the FCPV. The pressure relief valve can alternatively additionally direct fluid from the fuel supply to a purge reservoir. The system preferably additionally includes a check valve between the fuel cell arrangement and the fluid connection of the valve with the FCPV, wherein the check valve permits fluid flow from the fuel cell arrangement to the FCPV and prevents fluid flow in the opposing direction. To purge the system, the fuel supply valve is preferably switched to open the second outlet and seal the first outlet, such that fluid flow from the fuel supply to the FCPV is permitted. During the purge, the FCPV is preferably placed in an open configuration, such that the purge stream purges to ambient air. This can be achieved by increasing the fuel pressure beyond the FCPV cracking pressure, or actively placing the FCPV in an open configuration. The fuel supply is then operated (e.g., the fuel generator is initiated to generate fuel), wherein the produced fuel preferably gradually pushes the ambient air from the fuel connection upstream of the fuel supply valve. Alternatively, a pump can be used to pressurize the produced fuel to facilitate a rapid purge of the fuel cell system. When a pump is used, the fuel supply valve preferably seals both the first and second outlets to allow pressure to build up within the fuel supply. Once the purge pressure threshold is reached, the fuel supply valve is then switched to open the FCPV outlet and allow the pressurized fuel to flow through the system, purging ambient air from the fuel supply compartment and the section of the fuel connection proximal the fuel supply. However, the system can additionally include a passive valve near the fuel egress port (e.g., in the fuel supply dock and/or in the port) with a cracking pressure near the purge pressure threshold that allows the fuel supply to be pressurized to the purging pressure.

In a second variation, as shown in FIG. 5, ambient air is purged through the pressure release valve of the fuel supply. In this variation, the fluid within the fuel supply dock, fuel supply, and/or fuel connection are pressurized to a purging pressure and purged through the pressure release valve. This variation is preferably used with a fuel cell system including a supply valve located at the fuel egress port of the fuel supply or along the fuel connection, wherein the valve is preferably an active valve that can be maintained in the closed position (e.g., to prevent fluid flow into the fuel cell arrangement) during fuel cell system pressurization. However, the valve can be any suitable valve. The pressure release valve is preferably a one-way valve, more preferably a check valve, and can be active or passive (e.g., with a cracking pressure substantially near the purging pressure). Fuel is preferably used to pressurize the aforementioned purged cavities, and pressure is preferably generated by fuel generation and/or a pump.

In a third variation, as shown in FIGS. 6 and 7, the fuel supply consumes the ambient air trapped within the system. The ambient air within the fuel supply and any connections is preferably combusted within the fuel generator to pre-heat the fuel supply, and a drop in temperature serves as the purge completion signal. In this variation, the ambient air within the fuel supply dock, fuel supply, fuel connection, and/or fuel cell arrangement can be routed to the fuel generator. This variation is preferably utilized with a fuel supply including a catalyst that catalyzes fuel combustion in the presence of oxygen (preferably a component of the ambient air). Ambient air can be routed from the fuel cell purge valve (FCPV) downstream of the fuel cell arrangement (wherein the FCPV is preferably a three way valve with an inlet fluidly connected to the fuel cell arrangement, an ambient environment outlet and a fuel supply outlet). For example, the FCPV can receive fluid from the fuel cell anode outlets and direct the fluid to the ambient environment and/or the fuel supply. In operation, the ambient air within the fuel cell system is pushed by the pressure of the generated fuel to the fuel cell purge valve, wherein the fuel cell purge valve routes the egressed fuel cell air to the fuel supply to be consumed. Purge completion is satisfied when the fluid stream from the anode outlets comprise mainly unreacted fuel. In another example, the FCPV can be a valve that can receive fluid from the fuel connection and direct the fluid to the fuel cell arrangement, the ambient environment, and/or the fuel supply. In operation, the FCPV can direct air trapped within the fuel connection back into the fuel supply to be consumed and/or vent the trapped air to the ambient environment using the pressure generated within the fuel supply, thereby bypassing the fuel cell arrangement. In this variation, the FCPV or three-way valve is preferably an active valve. This variation can additionally include an active valve located near the fuel egress port of the fuel supply, such that fuel does not leak into the rest of the fuel cell system before substantially complete ambient air consumption. As fuel is produced from the fuel supply/fuel generator, the catalyst combusts the fuel with the ambient air trapped within the system. The resultant heat is preferably used to pre-heat the fuel supply to produce more fuel and/or to consume (e.g., evaporate) any remaining oxidants within the ambient air. Ambient air within the system can be pumped into the fuel supply, or can be drawn into the fuel supply by the vacuum created by the consumption of ambient air within the fuel generator. This variation can additionally include the step of purging the waste stream from the system. The combustion products are preferably purged from the FCPV (e.g., utilizing a fuel cell arrangement purge method, such as the one described in U.S. application Ser. No. 13/286,025, incorporated herein in its entirety by this reference, or by the first ambient air purge variation), and from the fuel supply (e.g., by generating enough fuel pressure to purge non-fuel gasses and reaction products from the fuel supply), but can be purged utilizing any other suitable purging system and method.

In a fourth variation, as shown in FIG. 8, ambient air is purged through the fuel cell arrangement and through the fuel cell purge valve (FCPV). In this variation, the fuel cell system is preferably pressurized by a pump or fuel generation, wherein the system is purged when the internal pressure reaches a purge pressure threshold. In this variation, the entire fuel cell system is preferably pressurized (e.g., the fuel supply, fuel supply dock, fuel connection, and fuel cell arrangement), but only a portion of the fuel cell system can be alternatively pressurized (e.g., only the fuel supply, fuel supply dock, and fuel connection), wherein the system includes the requisite valves (e.g., check valves) in suitable locations. In this variation, the FCPV is preferably fluidly connected to the fuel outlets of the fuel cells, and can be a passive valve with a cracking pressure substantially near the purge pressure threshold, or can be an active valve that is opened when the purge pressure threshold is reached. In one example of the fourth variation, the fuel connection can additionally include a supply valve permitting fluid flow from the fuel supply to the fuel cell arrangement, wherein the supply valve can be a passive valve having a cracking pressure above (e.g., substantially higher) the purge pressure threshold or can be an active valve. The fuel cell arrangement can additionally include a load regulator that controls the amount of power drawn from the fuel cell arrangement. In operation, the load regulator controls fuel cell system purging by adjusting the power draw on the system. Since the fuel is provided to the fuel cell arrangement at a higher pressure than the FCPV cracking pressure, a decrease in fuel consumption (i.e. a decrease in power draw) at the fuel cells results in an increased fuel cell internal pressure, eventually exceeding the FCPV cracking pressure and purging the system. An increase in fuel consumption (increase in power draw) decreases the fuel cell internal pressure, resulting in purge cessation. Fuel flow to the fuel cell during purging is preferably maintained at a substantially steady rate, but can alternatively be variable, wherein power draw is preferably regulated to accommodate for fuel flow rate variations. During startup, fuel generation can be initiated prior to fuel cell arrangement initiation, such that the generated fuel forces the ingressed air out of the fuel cell anodes prior to fuel cell startup.

In a fifth variation, ambient air is consumed by a fuel cell. More specifically, the purge stream from the fuel supply is routed over the fuel cell cathodes, wherein the cathodes exothermically reacts the air-fuel supply, simultaneously consuming the oxidants in the air and heating the fuel cell. The reaction products are preferably purged through the cathode air outlet. This variation preferably includes a three-way supply valve within the fuel connection, wherein the supply valve receives fluid from the fuel supply and selectively directs fluid to the fuel cell anode inlet(s) and/or the fuel cell cathode inlet(s). Alternatively and/or additionally, this variation can include a three-way pressure release valve that receives fluid from the fuel supply and selectively directs the fluid to a purge reservoir and/or the cathode inlet(s). When purging, the fluid channel between the fuel supply and the cathode inlets is preferably open while the fluid channel between the fuel supply and the second outlet (e.g., outlet to the purge reservoir or the anode inlets) is preferably sealed. Additionally, ambient air ingressed into the fuel cell anodes can additionally be purged, wherein the FCPV can be a three-way valve that receives fluid from the fuel cell anode outlet(s) and directs fluid to a purge reservoir (e.g., ambient environment) and/or to the fuel supply. However, the FCPV can be a one-way valve fluidly connecting the anode outlets to a purge reservoir, or be any other suitable valve.

Detecting a purge completion condition S300 functions to indicate the completion of a purge. A purge completion condition is preferably detected by a purge completion detector, wherein the controller preferably actuates the purge mechanism to cease purging after detection of purge completion. The purge completion detector preferably measures a parameter indicative of the fuel or air (e.g., oxygen) concentration within the fuel supply, but can measure any other suitable system parameter indicative of purge completion. The purge completion condition can be detected and/or actuated passively by the purge mechanism. For example, the purge valves can automatically close (thus, ceasing the purge) after the internal pressure drops below the purge pressure threshold. The purge is preferably ceased in response to the satisfaction of the purge completion condition.

In a first variation, the purge completion condition is the satisfaction of a predetermined purge duration (i.e. period of time). The purge duration is preferably selected to sufficiently purge the fuel supply without purging significant amounts of pure fuel. The purge completion condition is preferably determined by a timer, such as a timer within the controller of the purge mechanism. In one example, the purge duration can be several hundred miliseconds after purge initiation (e.g., 100 miliseconds, 300 miliseconds, etc.), wherein the purge is ceased when the purge duration is reached. The purge duration preferably corresponds to a substantially full purge of the fuel cell system (e.g., the time period is long enough to substantially purge the fuel supply, fuel supply dock, and fuel connection), wherein the purge duration is determined empirically. However, the purge duration can correspond with a purge cycle duration. In this variation, the fuel cell system is purged multiple times, preferably in quick succession, wherein the purge duration is the cycle duration of each purge cycle.

In a second variation, the purge completion condition is a pressure drop to or below the purge pressure threshold (as shown in FIG. 6). The purge completion condition is preferably passively determined by a purge valve, wherein the shutoff pressure is preferably substantially near the purge pressure threshold. However, the purge complete even can be determined by a pressure sensor or by any suitable means.

In a third variation, the purge completion condition is a temperature drop over a purge mechanism. In one example, the purge completion condition is a temperature drop in the air surrounding a catalyst or of the catalyst itself. The catalyst can be the same or a different catalyst as the purge condition detector. The catalyst can be located within the fuel supply, within the fuel connection, within the purge reservoir, or within any other suitable portion of the fuel cell system. In another example, the purge completion condition is a decrease in the heating rate of a cathode or the air adjacent a cathode. In this example, the purge stream is preferably routed over the cathode of a fuel cell within the fuel cell arrangement or over the cathode of a sacrificial fuel cell.

In a fourth variation, the purge completion condition is a voltage or power increase in a fuel cell, more preferably an increase to the preferred operational power/voltage of the fuel cell. In this variation, the purge stream is routed over the anode of a sacrificial fuel cell. An increase in voltage/power indicates the presence of fuel and an absence of ambient air within the purge stream. In one example, the sacrificial fuel cell is a fuel cell within the fuel cell assembly, wherein the purge stream is routed over the anode of a different fuel cell for each purge, such that the fuel cells of the fuel cell assembly are alternatively used as the sacrificial fuel cell.

In a fifth variation, the purge completion condition is a power decrease in a fuel cell, more preferably a decrease below a threshold power or voltage threshold. In this variation, the purge stream is routed over the cathode of a sacrificial fuel cell. A decrease in voltage or power from the sacrificial fuel cell indicates an absence of oxygen within the purge stream, indicative of a purge stream including primarily fuel.

In a sixth variation, the purge completion condition is the oxygen concentration within the purge stream falling below a predetermined oxygen concentration threshold, wherein the oxygen concentration threshold is indicative of an oxygen concentration that will not substantially damage or oxidize the anodes of the fuel cell. The oxygen concentration can be detected by an oxygen sensor, catalyst, or any other suitable oxygen sensor.

Ceasing the purge S400 functions to end the removal of ambient air from the system. This step is preferably performed automatically by the purge mechanism (e.g., the purge valves automatically close when the internal pressure falls below the purge pressure), but can alternatively be actively controlled by the controller. This step is preferably performed in response to the determination of a purge completion condition, and preferably includes reversing the purge initiation action. This step preferably includes the step of closing a purge valve, such as the fuel cell purge valve or the pressure release valve. However, this step can include the step of switching a three-way valve to open the fuel cell arrangement port and seal the purge to ambient port, switching off a pump, decreasing the fuel generation rate, increasing the load on the system, reversing the state of the purge mechanism to a state prior the purge, or any suitable action to cease the purge.

As a person skilled in the art will recognize from the previous detailed description and from the figures and claims, modifications and changes can be made to the preferred variations of the invention without departing from the scope of this invention defined in the following claims.

We claim:

1. A purge system for purging a fuel supply of a fuel cell system including a fuel cell, comprising:
a first valve that controls flow from the fuel cell to a purge reservoir;
a fuel supply compartment configured to receive a fuel cartridge;
a second valve located along the fuel connection, the second valve comprising a three-way valve fluidly connected to the fuel supply compartment, the fuel cell, and the first valve, wherein the second valve is operable between:
a bypass mode wherein the second valve directs fluid from the fuel supply compartment to the first valve bypassing the fuel cell;
a non-bypass mode wherein the second valve directs fluid from the fuel supply compartment to the fuel cell.

2. The system of claim 1, further comprising a purge line fluidly connecting the fuel cell and the first valve, wherein the second valve is fluidly connected to an intermediary portion of the fuel line.

3. The system of claim 2, further comprising a third valve located between the fuel cell and the first valve along the fuel line, the third valve comprising a one-way valve preventing fluid flow from the second valve to the fuel cell.

4. The system of claim 3, wherein the third valve comprises a passive valve.

5. The system of claim 1, wherein the first valve comprises a three-way valve including a first inlet fluidly connected to the fuel cell, a second inlet fluidly connected to the second valve, and an outlet fluidly connected to the purge reservoir.

6. The system of claim 1, wherein the second valve comprises an active valve, wherein the system further comprises a controller that controls operation of the second purge valve between the bypass mode and non-bypass mode.

7. A method for purging non-fuel gasses from a fuel supply of a fuel cell system, the fuel cell system further including a fuel cell stack, the method comprising:
measuring a first parameter indicative of fuel concentration within the fuel supply;
in response to the first parameter measurement satisfying a purge condition, wherein the purge condition is satisfied when the first parameter measurement is indicative of the fuel concentration below a predetermined concentration threshold, opening a purge valve fluidly coupled to the fuel supply and generating a purging pressure within the fuel supply to purge the fuel supply;
measuring a second parameter indicative of purge completion; and
in response to the second parameter measurement satisfying a purge completion condition, closing the purge valve.

8. The method of claim 7, further comprising fluidly connecting the fuel supply with a fuel cell of the fuel cell system in response to satisfying the purge completion condition.

9. The method of claim 7, wherein measuring the first parameter comprises determining the connection state of a fuel cartridge with the fuel supply; wherein the purge condition is satisfied when the connection state of a first cartridge is determined to be disconnected from the fuel cell system and the connection state of a second cartridge is determined to be connected to the fuel cell system.

10. The method of claim 7, wherein measuring the first parameter comprises measuring a parameter indicative of an operation state of the fuel cell system, wherein the purge condition is satisfied when the parameter measurement is determined to be indicative of fuel cell system startup.

11. The method of claim 10, wherein measuring a parameter indicative of fuel cell system operation state comprises measuring a temperature of a fuel cell, wherein the purge condition is satisfied when the temperature measurement is below a predetermined temperature threshold.

12. The method of claim 7, wherein measuring the first parameter comprises measuring a parameter indicative of oxygen concentration within the fuel supply, wherein the purge condition is satisfied when the first parameter measurement is indicative of the oxygen concentration exceeding a predetermined oxygen concentration threshold.

13. The method of claim 12, wherein measuring a parameter indicative of oxygen concentration within the fuel supply comprises measuring a temperature above a catalyst bed within the fuel supply, wherein the catalyst exothermically reacts oxygen with fuel.

14. The method of claim 7, wherein the purge valve comprises a three-way valve fluidly connecting the fuel supply with a fuel cell and a purge stream reservoir; wherein opening the purge valve comprises fluidly connecting the purge stream reservoir with the fuel supply and fluidly disconnecting the fuel supply from the fuel cell; wherein closing the purge valve comprises fluidly connecting the fuel cell with the fuel supply and fluidly disconnecting the purge stream reservoir from the fuel cell.

15. The method of claim 8, wherein the fuel cell system further comprises a second purge valve fluidly connecting an anode outlet of the fuel cell stack to the purge stream reservoir, wherein the first purge valve fluidly connects to the second purge valve such that the first purge valve is fluidly connected to the purge stream reservoir through the second purge valve.

16. The method of claim 15, wherein the fuel cell system further comprises a third valve disposed between the second purge valve and the fuel cell stack, wherein opening a purge valve fluidly coupled to the fuel supply and generating a purging pressure within the fuel supply to purge the fuel supply further comprises closing the third valve.

17. The method of claim 7, wherein the fuel supply comprises a fuel generator, wherein generating the purging pressure comprises initiating fuel generation, wherein the pressure of the generated fuel comprises the purging pressure.

18. The method of claim 7, wherein measuring a parameter indicative of purge completion comprises measuring a parameter indicative of the fuel concentration within the purge stream.

19. The method of claim 23, wherein measuring a parameter indicative of the fuel concentration within the purge stream comprises measuring the temperature of a catalyst bed located within the purge stream, wherein the purge completion condition is met when the measured temperature falls below a predetermined temperature threshold.

20. The method of claim 19, wherein measuring a parameter indicative of purge completion comprises measuring a power output from a fuel cell, wherein the purge completion condition is satisfied when the power output increases beyond a predetermined power threshold.
